(19) United States
(12) Patent Application Publication
(10) Pub. No.: US 2013/0080449 A1
(43) Pub. Date: Mar. 28, 2013

(54) System and Method for Aggregating Contextual Content

(71) Applicants: Edmon W. O. Chung, Hong Kong SAR (CN); Sin Ling LIU, Hong Kong SAR (CN)

(72) Inventors: Edmon W. O. Chung, Hong Kong SAR (CN); Sin Ling LIU, Hong Kong SAR (CN)

(21) Appl. No.: 13/427,880

(22) Filed: Mar. 23, 2012

Related U.S. Application Data
(60) Provisional application No. 61/466,681, filed on Mar. 23, 2011.

(51) Int. Cl. G06F 17/30

(52) U.S. Cl. 707/749; 707/E17.033

(57) ABSTRACT

Systems, devices and methods for aggregating contextual content are disclosed. In some embodiments, an evolving subject work is analyzed, potentially relevant works are retrieved, and the potentially relevant works are categorized and presented.

### CROSS-REFERENCE TO RELATED APPLICATION

This application claims priority to U.S. Provisional Patent Application Ser. No. 61/466,681 filed Mar. 23, 2011, which is incorporated by reference in its entirety as if fully set forth herein.

### TECHNICAL FIELD

The present application generally relates to information technology for assisting research and/or writing. More specifically, the present application relates to systems, devices and methods for dynamically identifying and providing content based on the evolving content of a work.

### BACKGROUND

Systems, devices and methods identifying relevant content based on a textual work are well known. Known systems, devices and methods in the field do not adequately identify and provide relevant content dynamically as the textual work is being created and/or edited. Further, known systems, devices and methods in the field may unduly limit the scope of relevant content, for example, by storage medium.

Accordingly, there is a need for effective systems, devices and methods that dynamically identify and provide relevant content based on an evolving source work.

### SUMMARY

According to a first aspect of the present application, a method is disclosed for aggregating contextual content in a computerized system. The method comprises analyzing a subject work. The analyzing comprises: segmenting the subject work, identifying and tagging expressions of the subject work, weighting the expressions of the subject work, compiling relevant expressions; compiling opposing expressions, and generating ranked keywords of the subject work.

The method further comprises retrieving potentially relevant works. The retrieving comprises: selecting at least one of a plurality of resources, analyzing each of the potentially relevant works, and ranking relevance of the potentially relevant works. The method still further comprises categorizing the potentially relevant works and presenting the potentially relevant works.

According to a second aspect of the present application, a computerized system is disclosed for aggregating contextual content. The system comprises a processor and a memory storing control instructions, and the processor is operatively connected to the memory for processing the control instructions to: analyze a subject work; retrieve potentially relevant works; categorize the potentially relevant works; and present the potentially relevant works.

The analyzing comprises: segmenting the subject work, identifying and tagging expressions of the subject work, weighting the expressions of the subject work, compiling relevant expressions; compiling opposing expressions, and generating ranked keywords of the subject work. The retrieving comprises: selecting at least one of a plurality of resources, analyzing each of the potentially relevant works, and ranking relevance of the potentially relevant works.

### BRIEF DESCRIPTION OF THE DRAWINGS

The accompanying figures, which are incorporated in and constitute a part of the specification, illustrate various example systems, devices methods, and so on, and are used merely to illustrate various example embodiments. It should be noted that the various assemblies and elements depicted in the figures are presented for purposes of illustration only, and should not be considered in any way as limiting.

FIG. 1 is a schematic block diagram illustrating an example environment for the systems, devices and methods of the present application.

FIG. 2 is flowchart illustrating an example methodology for analyzing a subject work.

FIG. 3 is flowchart illustrating an example methodology for analyzing relationships of expressions in a subject work.

FIG. 4 is flowchart illustrating an example methodology for retrieving potentially relevant works.

FIG. 5 is flowchart illustrating an example methodology for presenting relevant works.

### DETAILED DESCRIPTION

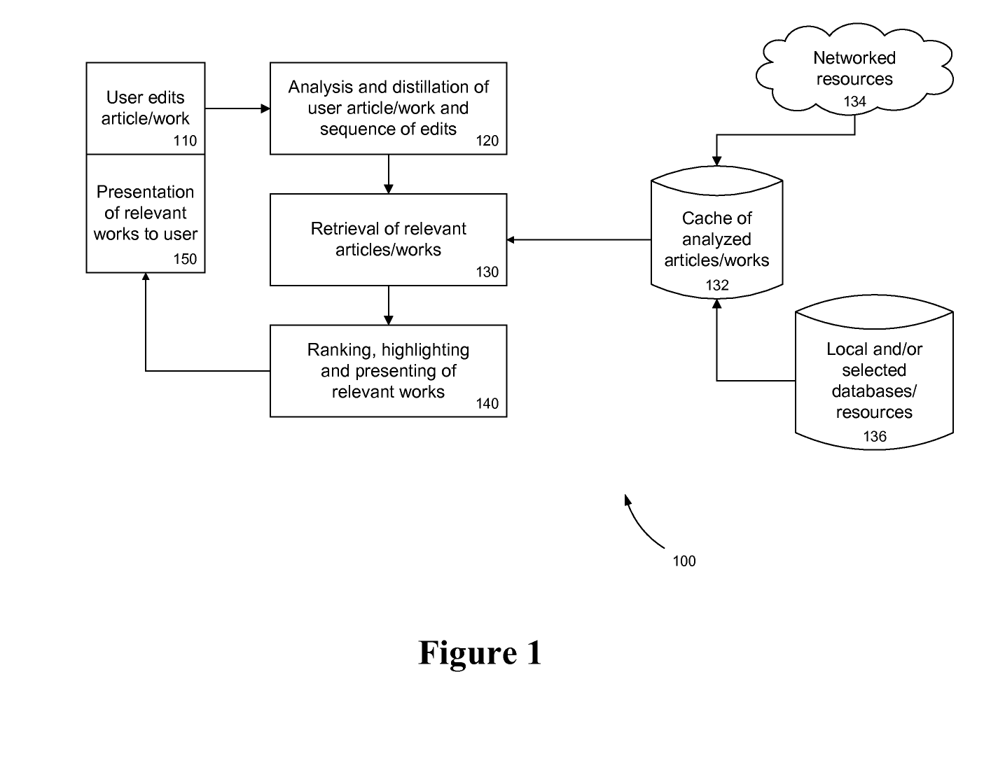

The present application describes display systems, devices and methods for aggregating contextual content based on an evolving work. An example operating environment 100 in accordance with this disclosure may be employed as generally illustrated in FIG. 1. As shown at block 110, a user edits a subject work. At block 120, a computerized system analyzes the subject work. At block 130, the computerized system retrieves potentially relevant works. The potentially relevant works may be retrieved form a cache of analyzed works 132 that may be populated by network resources 134 and/or local and/or selected resources 136. The potentially relevant works may be ranked, highlighted and presented to the user as illustrated at blocks 140 and 150.

One advantage of the system and method of the present application is the dynamic consideration of contextual edits by the user on the current work. Such consideration may be incorporated into the analysis of the subject work 120. Instead of simply analyzing and distilling a subject work in its entirety like typical search technologies, the system and method of the present application takes into consideration the most recent edits and sequence of edits of the subject work to determine the potentially relevant works to be retrieved and presented to the user.

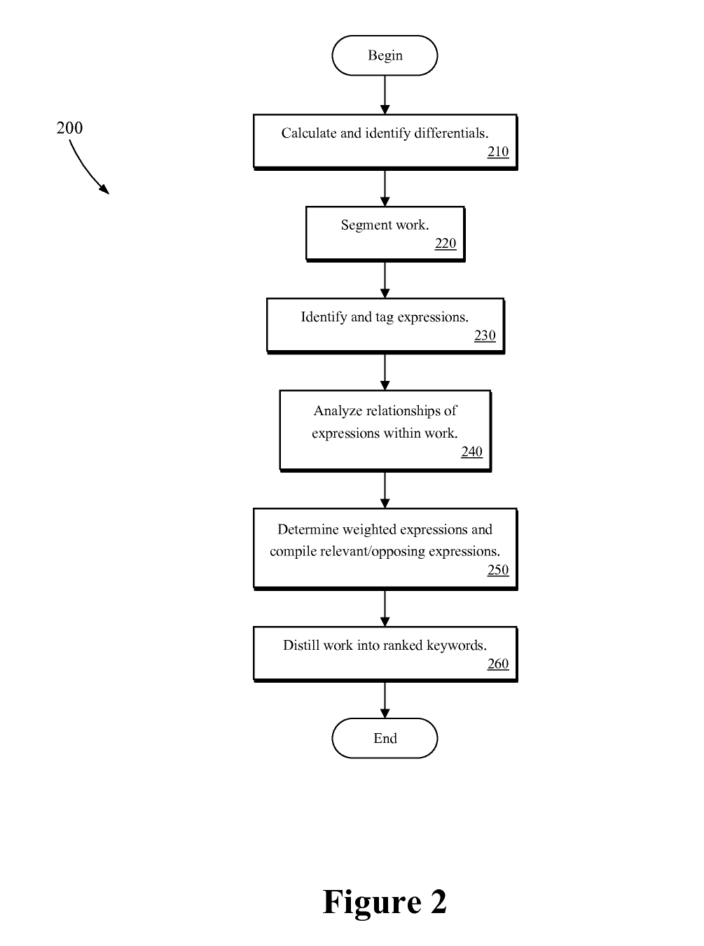

Referring now to FIG. 2, a flowchart is depicted illustrating an example methodology 200 which may be employed by the computerized system to analyze a subject work. At block 210, the computerized system calculates and identifies differentials.

The system and method of the present application may iteratively or continuously log substantive changes and times of changes a user applies to the subject work. The most recent changes/edits to a work may be more relevant than prior changes. The significance of the change may also be considered based on both: whether phrases or significant expressions are created or changed; and whether the density of expressions are changed. Minor edits, such as typographical, styling, prepositions, etc. that do not affect the weighting or ranking of distilled keywords may also be identified and set aside.

At block 220, the subject work is segmented. The computerized system breaks down the subject work into segments and sub-segment such as, for example, headings, paragraphs and sentences. This allows comparison of expression statistics within and across segments. For example, density of an expression within a paragraph/segment may be calculated versus the average density of an expression across multiple paragraphs/segments. Segments also allow for the consideration of the context for which the most recent edits were made.

While segments may describe the contextual boundary, expressions are unitary elements and combinations/congregations such as, for example, words and phrases. At block 230, each identified expression may be tagged by the computerized system. A sub-expression may also be considered an expression. For example, a word within a phrase as well as the phrase itself are both considered expressions.

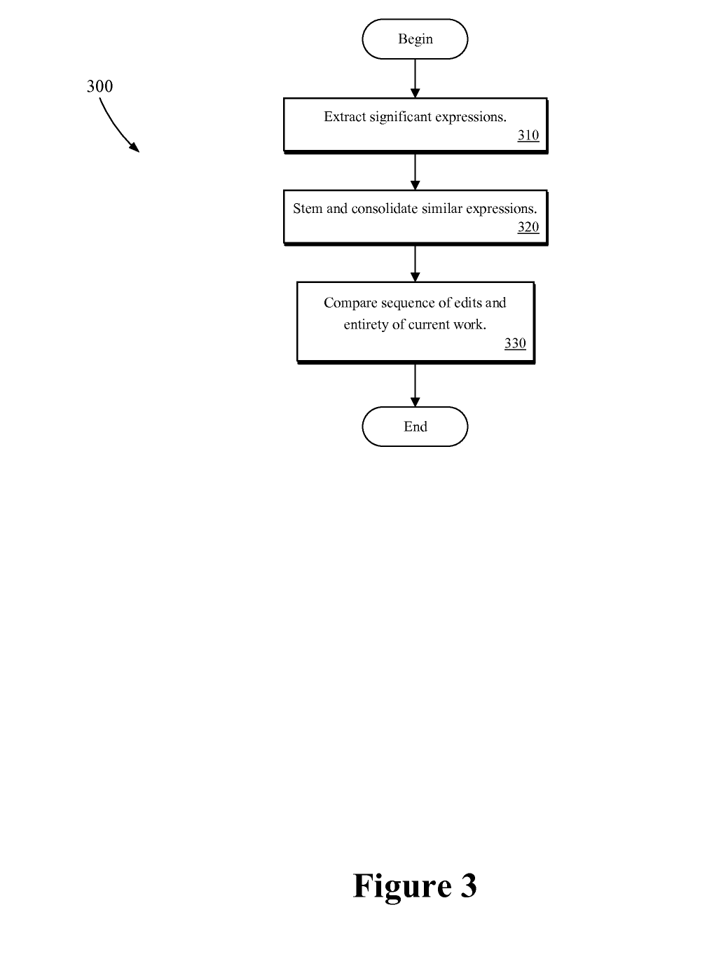

At block 240, the computerized system analyzes relationships of expressions within the subject work. By utilizing natural language processing techniques, as well as other work characteristic tools such as musical or image fingerprint/trait algorithms, the more significant expressions within the subject work may be identified. Specifically, words and phrases that convey the meaning or distinctive feature of the work may be identified. Referring now to FIG. 3, there is illustrated an example methodology 300 for analyzing relationships of expressions in the subject work according to block 240.

The significance of an expression, illustrated at block 310, may be used to determine the weight of such expression in the ranking of finally distilled keywords as well as to the importance of an edit/change. The nature of an expression may also be identified, such as, for example, whether an expression is: an opinion such as “like” or “hate”; a description or statement of information such as “blue shirt” or “north wind”; a description or statement of context, such as time and/or location, including for example “yesterday”, “library”, or “New York.” The nature of an expression may then be used to determine and compile relevant and/or opposing expressions of interest.

At block 320, similar expressions may be stemmed and consolidated. Utilizing natural language processing techniques, and/or other work characteristic tools such as musical or image fingerprint/trait algorithms, similar expressions may be grouped together or “stemmed.” For example, tenses, plurality, variations of the same ontological word/expression may be identified. Stemmed expressions may further be organized based on their degree of similarity. The density of such expressions, within a segment or across segments, may be used later in the determination of the weight of the expression.

At block 330, the computerized system may compare the sequence of edits and the entirety of the subject work. The computerized system may analyze the rate of change of expressions based on the log of changes/edits by a user. For example, comparisons may be made regarding the increase in instances of an expression, either within a segment and/or across segments. In another example, comparisons may be made to determine a rise of ranking of an expression over time.

Utilizing the log of expression rankings for the current subject work against previous work or retrieved works, the computerized system may also be able to identify similar patterns, such as chains of thoughts, in order to provide more relevant works to the user as well as to anticipate the trajectory of thoughts, such as to guess what the user might wish to write about next.

In predicting relevant works based on relevant expressions, multiple types of sequences/pattern matches may be considered. For example, Editorial Sequence, which is the sequence in which a previous work was created/edited by the user or by others. Another example is Contextual Sequence, which is the natural flow of a work, such as how an article would be read, or for music or videos, how it will be played, and for images the natural eye patterns for an image. Also, consideration of the availability of prior works by the user or user group may be used to improve relevance precision.

Referring back to FIG. 2, at block 250, the computerized system determines the weight of the tagged expressions. The computerized system further compiles relevant and/or opposing expressions to ultimately distil the subject work into a ranked mesh of keywords. The rankings may be determined by weights assigned to each tagged expression based on criteria, which may include but are not limited to: (1) importance of the expression and (2) importance of the edit. Set forth below are tables I and II providing examples of these exemplary criteria:

TABLE I
Importance of Expression:

| | Within | Among | Across | Entirety |
|---|---|---|---|---|
| | Segment | Segments | Segments | of Work |
| Frequency of | The higher the | The higher the | The higher the | The higher the |
| expression | frequency of the | frequency of the | average | frequency of the |
| | expression | expression | frequency of the | expression in |
| | within the | within the | expression across | the work, the |
| | segment, the | segment among | segments the | stronger the |
| | stronger the | other segments, | stronger the | weight |
| | weight | the stronger the | weight | |
| | | weight | | |

| | |
|---|---|
| Rate of Change | The more rapid the increase in frequency of the expression the stronger the |
| in Frequency* | weight |
| Rate of Change | The more rapid the rise in rank of the expression (versus other expressions) |
| in Rank* | the stronger the weight |
| Historical Trend | For both Editorial Sequence and Contextual Sequence, the stronger the |
| of Previous | match of the set of expressions and rate of change in frequency and |
| Works | rank of expressions against historical work, the stronger the weight |

*Additional weighting may be applied based on the segmentation weights

TABLE II
Importance of Edit

| | |
|---|---|
| Significance of Expression | The higher the significance the stronger the weight. |
| Edited | |
| Weight of Expression Edited | The stronger the weight of an expression the stronger the |
| | weight. |
| Nature of Expression Edited | The higher the contrast of the change of an opinion, such as |
| | from big to small, or from like to hate, for example, the |
| | stronger the weight. |
| | The further the difference of a change in a statement of context |
| | the stronger the weight. |
| | The higher the contrast of the change of descriptor of a |
| | statement of information the stronger the weight. |
| | The change in an opinion has stronger weight, than the change |
| | in a statement of context, than the change in a statement of |
| | information. |

Besides the distilled keywords based on weighted tagged expressions, the computerized system may also generate and compile a set of relevant expressions. The nature of higher ranked tagged expressions may be considered. Exemplary expressions may include:
For identified opinions, opposing and/or contrasting expressions may be generated;
For identified statements of information, complementary and/or contrasting expressions may be generated; and
For identified statements of context, a relevant scope may be used (such as, for example, date/location).

The computerized system may generate an “Interpretation Profile” comprising multiple sets of ranked/weighted keywords, including but not limited to:
Expressions distilled from work user is working on;
Generated expressions based on relevant/opposing/contrasting expressions; and
Generated expressions based on projected trajectory or “chain of thought.”

For expressions distilled from the work the user is working on, the weights may be based on the weighting algorithm as explained with regard to Tables I and II, above. It is possible that some expressions may have equal weights, and therefore equal ranks. The ranking of retrieved relevant works will be further explained below.

For generated expressions based on relevant/opposing/contrasting expressions, the ranking may be determined by the ranking of the corresponding expression.

For generated expressions based on projected trajectory or “chain of thought,” the ranking of the generated expressions is based on the corresponding historical data.

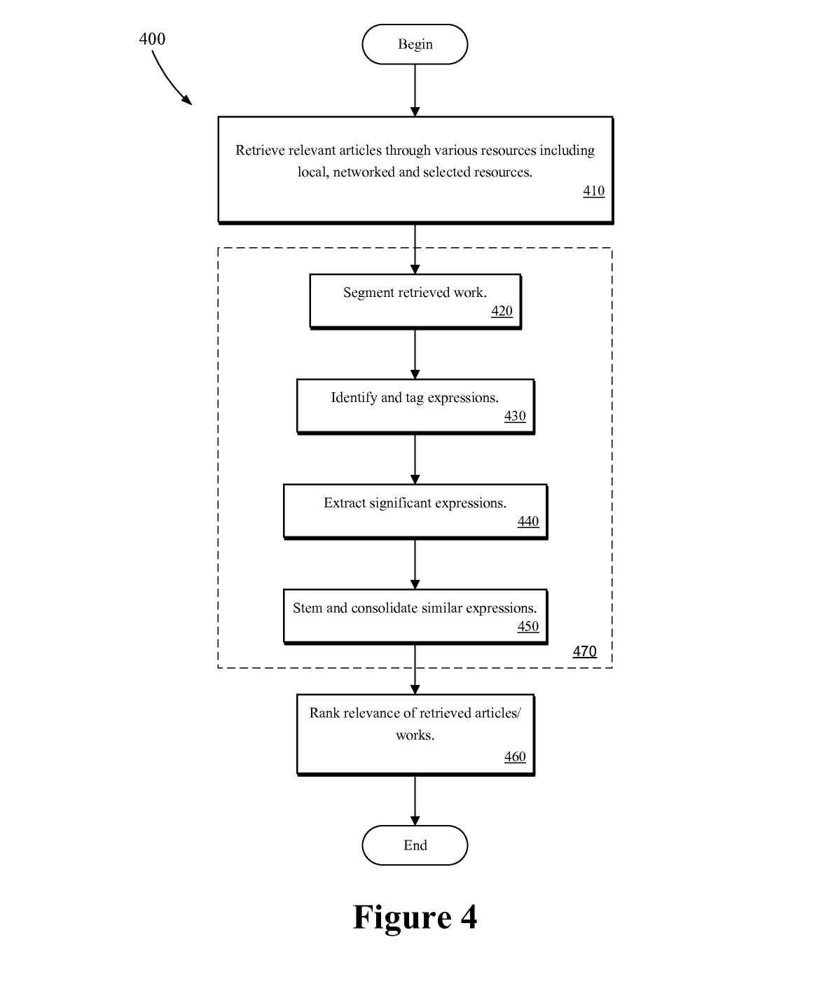

Referring now to FIG. 4, a flowchart is depicted illustrating an example methodology 400 for retrieving potentially relevant works. At block 410, the computerized system retrieves potentially relevant works through various resources, including local, networked and selected resources. The computerized system may utilize the set of keywords (expressions) to dynamically search multiple external databases. Upon obtaining the data of potentially relevant works, the retrieved works may be analyzed in a similar fashion as described with respect to the subject work before being compared and ranked.

If cached or pre-analyzed data is available, the Interpretation Profile(s) of the retrieved works may be used for comparison and ranking. Furthermore, the performance of the methodology may also be dependent on whether cached and pre-analyzed data is available.

The computerized system may search contents of local resources in the computer, such as text documents, for example, using the keywords (expressions) of the distilled Interpretation Profile. Potentially relevant works may be further analyzed for their relevance.

Using the keywords (expressions) of the distilled Interpretation Profile, the computerized system may target its search on specifically pre-selected resources. Depending on the implementation and/or usage of the methodology, the computerized system may target its search based on one or more criteria, which may include but is not limited to:
specified local resources, such as, for example, text documents only, within a folder, emails stored locally;
specified network resources, such as, for example, by domain and/or website, by IP address, or by corporate intranet; or
specified subset and/or scope, such as, for example, social networking “friends,” or contact lists.

In order to target its search on selected resources, the computerized system may retain information provided by the user, including but not limited to:
configuration: such as, for example, folder and/or URL to search for; and
credentials: such as, for example, login for certain databases/websites such as social networking websites.

The computerized system and methodology may also utilize the distilled keywords (expressions) for general searches to network resources. Multiple queries may be performed for multiple keywords.

The analysis of retrieved works is similar to the analysis described above with respect to the subject work, except that the identification of differential edits and the ranking of the importance of edits are not applicable.

Interpretation Profiles may be constructed based on:
Block 420—Segmentation of work (block 220);
Block 430—Tagging of expressions (block 230);
Block 440—Extraction of significance of expression (block 310); and,
Block 450—Stemming and consolidation of expressions (block 320).
Which produces a set of weighted expressions (block 250)
And a generated set of contrasting/opposing expressions (block 260)

For multiple segment works, an overall Interpretation Profile as well as interpretation profiles for each segment may be constructed.

In determining the ranking of relevance of potentially relevant retrieved works at block 460, the Interpretation Profile of the work the user is currently working on, as described with reference to block 260 above, and those of the retrieved works, as described with respect to blocks 420-450 above, will be compared. The higher the likeliness of match between the interpretation profile, the higher the rank for the retrieved work.

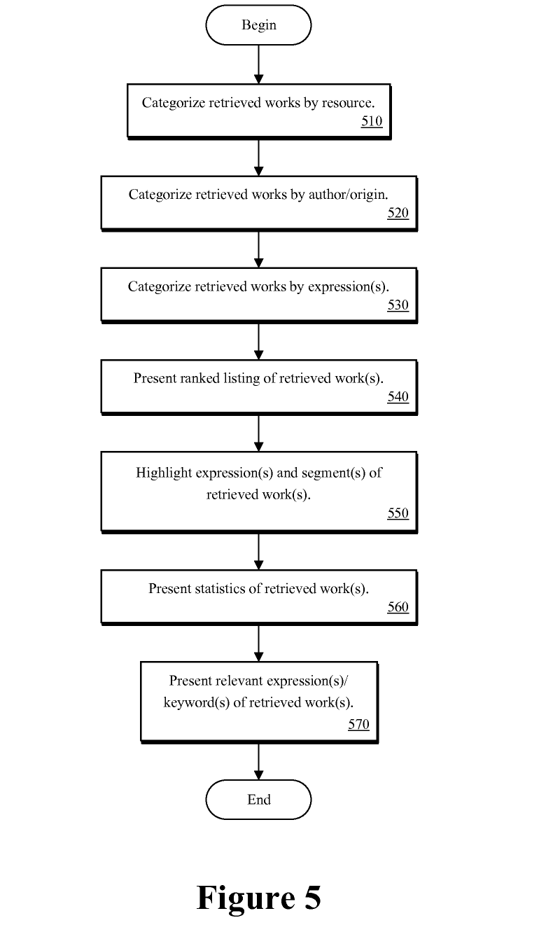

Referring now to FIG. 5, there is a flowchart illustrating an example methodology 500 for presenting relevant works. As illustrated, in addition to merely presenting an overall ranking, the methodology may also present the retrieved potentially relevant works according to different categories as described below.

Based on the specific implementation or user preference, the computerized system may use methodology 500 to present the ranked list of retrieved relevant works based on various views. As shown at block 510, the potentially relevant works may be categorized according to resource or type of resource. A listing/ranking of retrieved works may be presented in separate lists based on the source of the work, such as, for example, the website, or by type of resource, such as, for example, reference, press, or social media.

As shown at block 520, the potentially relevant works may be categorized according to author and/or origination. A listing/ranking of retrieved works based on the author or originator, such as, for example, friends, group of friends, specific blogger, or group of bloggers.

As shown at block 530, the potentially relevant works may be categorized according to relevance. Additional listing may be presented based on opposing/contrasting expressions and/or works based on anticipated trajectory, as discussed with reference to block 330.

Of course, one of ordinary skill will appreciate that other categorizations are also possible. The categorization allows retrieved potentially relevant works to be presented more clearly to the user. For example, on the sidebar of the user interface, the user could see multiple sections, including but not limited to:
reference materials: such as, for example Wikipedia, dictionary, press, etc.;
friends: such as, for example, posts from friends' blogs, social networking sites, etc.; and
general: such as, for example, other relevant articles.

The user may quickly get a sense of the relevance and context of the retrieved works. Further the user may get a sense of what his/her friends views are on the topic the user is working on.

In presenting the retrieved works to the user, the computerized system performing methodology 500 can offer more traditional ranked listings. For example, as set forth at block 540, results may be presented to the user according to a ranked listing of retrieved works. The works may be ranked based on block 460 and presented based on categorical sections as described in blocks 510-530.

As set forth at block 550, results may be presented to the user utilizing highlighting of expressions and segments. For example, special highlights of contents within retrieved works may be presented based on expressions identified in the Interpretation profile described with respect to block 260.

The retrieved works may also be presented in more summarized forms. For example, as shown at block 560, statistics from retrieved works may be presented to the user. The summarized statistics may describe keyword appearances within a retrieved work or across retrieved works.

Similarly, as shown at block 570, relevant expressions and other works based on retrieved works may be presented to the user. Of course, one of ordinary skill in the art will appreciate that numerous other forms of presentation may be further developed.

While the systems, methods, and so on have been illustrated by describing examples, and while the examples have been described in considerable detail, it is not the intention of the applicant to restrict, or in any way, limit the scope of the appended claims to such detail. It is, of course, not possible to describe every conceivable combination of components or methodologies for purposes of describing the systems, methods, and so on provided herein. Additional advantages and modifications will readily appear to those skilled in the art. Therefore, the invention, in its broader aspects, is not limited to the specific details and illustrative examples shown and described. Accordingly, departures may be made from such details without departing from the spirit or scope of the applicant's general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

Finally, to the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995).

What is claimed is:

1. A method for aggregating contextual content in a computerized system, the method comprising:
analyzing a subject work, the analyzing comprising:
segmenting the subject work,
identifying and tagging expressions of the subject work,
weighting the expressions of the subject work,
compiling relevant expressions;
compiling opposing expressions, and
generating ranked keywords of the subject work;
retrieving potentially relevant works, the retrieving comprising:
selecting at least one of a plurality of resources,
analyzing each of the potentially relevant works, and
ranking relevance of the potentially relevant works;
categorizing the potentially relevant works; and
presenting the potentially relevant works.

2. The method of claim 1 wherein the identifying and tagging comprises extracting a significant expression.

3. The method of claim 1 wherein the identifying and tagging comprises stemming and consolidating like expressions.

4. The method of claim 1 wherein the identifying and tagging is based on comparing a sequence of edits of the subject work to a whole of the subject work.

5. The method of claim 1 wherein the plurality of resources comprises a local resource.

6. The method of claim 1 wherein the plurality of resources comprises a networked resource.

7. The method of claim 1 wherein analyzing each of the potentially relevant works comprises:
segmenting each of the potentially relevant works;
tagging expressions of each of the potentially relevant works;
extracting significant expressions from each of the potentially relevant works; and
stemming and consolidating like expressions of each of the potentially relevant works.

8. The method of claim 1 wherein categorizing the potentially relevant works comprises categorizing the potentially relevant works by resource.

9. The method of claim 1 wherein categorizing the potentially relevant works comprises categorizing the potentially relevant works by author.

10. The method of claim 1 wherein categorizing the potentially relevant works comprises categorizing the potentially relevant works by expressions.

11. The method of claim 1 wherein presenting the potentially relevant works comprises presenting a ranked listing of the potentially relevant works.

12. The method of claim 1 wherein presenting the potentially relevant works comprises highlighting the expressions of the potentially relevant works.

13. The method of claim 1 wherein presenting the potentially relevant works comprises presenting statistics based on the potentially relevant works.

14. The method of claim 1 wherein presenting the potentially relevant works comprises presenting keywords based on the potentially relevant works.

15. A computerized system for aggregating contextual content, the system comprising:
a processor;
a memory storing control instructions; and
the processor is operatively connected to the memory and processing the control instructions to:
analyze a subject work, the analyzing comprising:
segmenting the subject work,
identifying and tagging expressions of the subject work,
weighting the expressions of the subject work,
compiling relevant expressions;
compiling opposing expressions, and
generating ranked keywords of the subject work;
retrieve potentially relevant works, the retrieving comprising:
selecting at least one of a plurality of resources,
analyzing each of the potentially relevant works, and
ranking relevance of the potentially relevant works;
categorize the potentially relevant works; and
present the potentially relevant works.

16. The system of claim 15 wherein the identifying and tagging comprises extracting a significant expression.

17. The system of claim 15 wherein the identifying and tagging comprises stemming and consolidating like expressions.

18. The system of claim 15 wherein the identifying and tagging is based on comparing a sequence of edits of the subject work to a whole of the subject work.

19. The system of claim 15 wherein analyzing each of the potentially relevant works comprises:
segmenting each of the potentially relevant works;
tagging expressions of each of the potentially relevant works;
extracting significant expressions from each of the potentially relevant works; and
stemming and consolidating like expressions of each of the potentially relevant works.

20. The system of claim 15 wherein the processor is operatively connected to the memory and processing the control instructions to present a ranked listing of the potentially relevant works.

21. The system of claim 15 wherein presenting the potentially relevant works comprises presenting a ranked listing of the potentially relevant works.
